(19) United States
(12) Patent Application Publication
(10) Pub. No.: US 2013/0076193 A1
(43) Pub. Date: Mar. 28, 2013

(54) LAMINATED CORE AND FABRICATION METHOD THEREOF

(71) Applicants: Changsung Sean Kim, Gyunggi-do (KR); Guen Hong LEE, Seoul (KR); Han Kyung BAE, Gyunggi-do (KR); Chang Hwan CHOI, Gyunggi-do (KR); Ji Hye SHIM, Gyunggi-do (KR)

(72) Inventors: Changsung Sean Kim, Gyunggi-do (KR); Guen Hong LEE, Seoul (KR); Han Kyung BAE, Gyunggi-do (KR); Chang Hwan CHOI, Gyunggi-do (KR); Ji Hye SHIM, Gyunggi-do (KR)

(73) Assignee: SAMSUNG ELECTRO-MECHANICS CO., LTD., Gyunggi-do (KR)

(21) Appl. No.: 13/338,634

(22) Filed: Dec. 28, 2011

(30) Foreign Application Priority Data
Sep. 28, 2011 (KR) 1020110098535

(51) Int. Cl. H02K 1/12; H02K 15/00

(52) U.S. Cl. 310/216.017; 29/596; 310/216.004

(57) ABSTRACT

Disclosed herein is a laminated core used for a motor including an electric motor, wherein the core is formed of a soft magnetic composite and has a structure in which one or more unit laminates are laminated. Since the core is fabricated by laminating soft magnetic composites, the mechanical strength of the core formed of the soft magnetic composites can be improved.

### CROSS REFERENCE TO RELATED APPLICATION

This application claims the benefit of Korean Patent Application No. 10-2011-0098535, filed on Sep. 28, 2011, entitled “Laminated Core and Manufacturing Method Thereof”, which is hereby incorporated by reference in its entirety into this application.

### BACKGROUND OF THE INVENTION

1. Technical Field

The present invention relates to a laminated core and a fabrication method thereof

2. Description of the Related Art

Generally, a motor such as an electric generator, an electric motor, or the like, is formed to have a structure in which windings (or coils) are inserted in a rotor core and a stator core within a case (an outer case, a box, tank, housing, or the like).

In this case, as for the rotor core and the stator core, a silicon thin film steel plate is punched to form a core, and a plurality of cores are laminated, and here, the cores are laminated such that an air gap is formed therebetween.

However, when the silicon steel plates are laminated to be used, a loss of an eddy current is high, efficiency is degraded, and a usage amount of copper is increased.

Thus, in order to solve the problem, in fabricating a core, a method of using a magnetic powder material has been proposed. Japanese Patent Laid Open Publication No. 1994-245456 discloses a method of reducing magnetic resistance of a magnetic path between cores and improving efficiency by forming a core as a molded product of soft magnetic metal-based powder.

However, when the core is integrally formed, like the molded product using the magnetic powder material, or the like, a fatal problem occurs in that mechanical strength is degraded.

### SUMMARY OF THE INVENTION

The present invention has been made in an effort to provide a laminated core fabricated by laminating soft magnetic composites to thus make the most of the characteristics of the soft magnetic composite and increase mechanical strength, and a fabrication method thereof.

According to a preferred embodiment of the present invention, there is provided a laminated core used for a motor including an electric motor, wherein the core is formed of a soft magnetic composite and has a structure in which one or more unit laminates are laminated.

An insulating layer may be laminated between the unit laminates in the soft magnetic composite lamination structure.

Each of the unit laminates of the soft magnetic composite lamination structure may have a thickness of 1 mm or smaller in a lamination direction.

According to a first preferred embodiment of the present invention, there is provided a method for fabricating a laminated core, including: forming a unit laminate by using a soft magnetic composite through a spin-coating method; and laminating a plurality of unit laminates in a thicknesswise direction.

An insulating layer may be further laminated between the unit laminates.

Each of the unit laminates may have a thickness of 1 mm or smaller in a lamination direction.

According to a second preferred embodiment of the present invention, there is provided a method for fabricating a laminated core, including: forming a unit laminate by using a soft magnetic composite through a slot die coating method; and laminating a plurality of unit laminates in a thicknesswise direction.

An insulating layer may be further laminated between the unit laminates.

Each of the unit laminates may have a thickness of 1 mm or smaller in a lamination direction.

According to a third preferred embodiment of the present invention, there is provided a method for fabricating a laminated core, including: forming a unit laminate by using a soft magnetic composite through a screen printing method; and laminating a plurality of unit laminates in a thicknesswise direction.

An insulating layer may be further laminated between the unit laminates.

Each of the unit laminates may have a thickness of 1 mm or smaller in a lamination direction.

### BRIEF DESCRIPTION OF THE DRAWINGS

FIG. 1A is a perspective view of a stator core employing laminated cores according to an embodiment of the present invention;

FIG. 1B is a perspective view of a stator core employing laminated cores according to another embodiment of the present invention;

FIG. 2 is a schematic view showing a method for forming a laminated core according to a first embodiment of the present invention;

FIG. 3 is a schematic view showing a method for forming a laminated core according to a second embodiment of the present invention;

FIG. 4 is a schematic view showing a method for forming a laminated core according to a third embodiment of the present invention; and

FIG. 5 is a view showing a method for forming a laminated core by using Gravure roll printing according to a fourth embodiment of the present invention.

### DESCRIPTION OF THE PREFERRED EMBODIMENTS

Various features and advantages of the present invention will be more obvious from the following description with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the tam to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. In the description, the terms “first”, “second”, “one surface”, “the other surface” and so on are used to distinguish one element from another element, and the elements are not defined by the above terms. In describing the present invention, a detailed description of related known functions or configurations will be omitted so as not to obscure the gist of the present invention.

Hereinafter, preferred embodiments of the present invention will be described in detail with reference to the accompanying drawings.

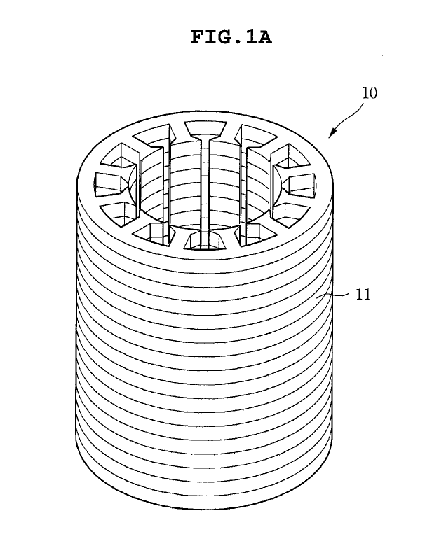

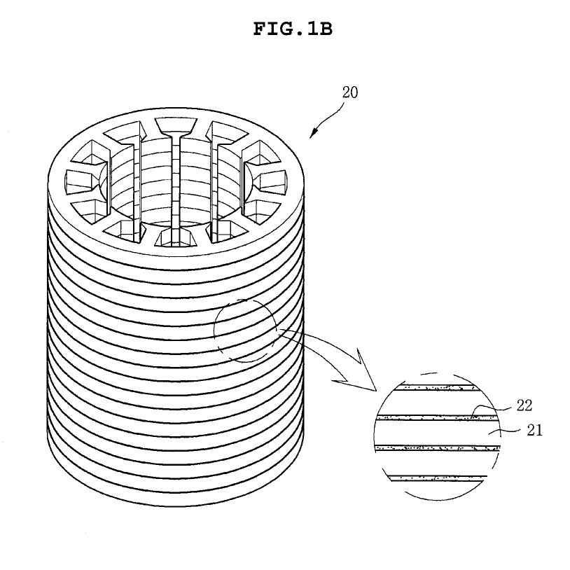

FIG. 1A is a perspective view of a stator core employing laminated cores according to an embodiment of the present invention, and FIG. 1B is a perspective view of a stator core employing laminated cores according to another embodiment of the present invention.

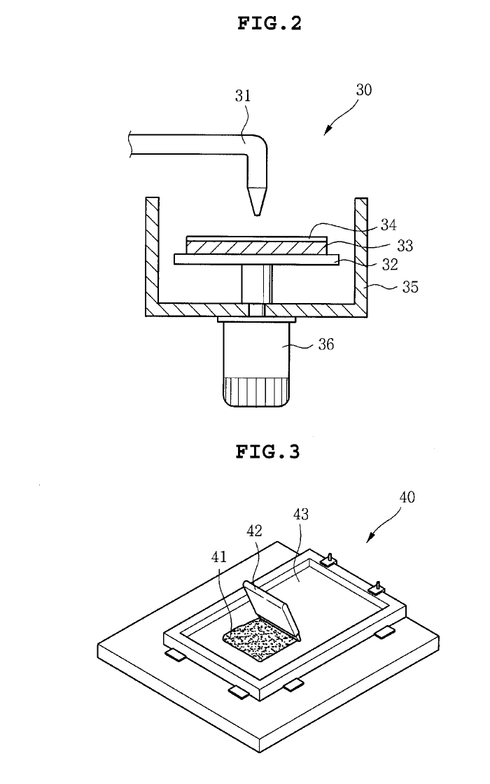

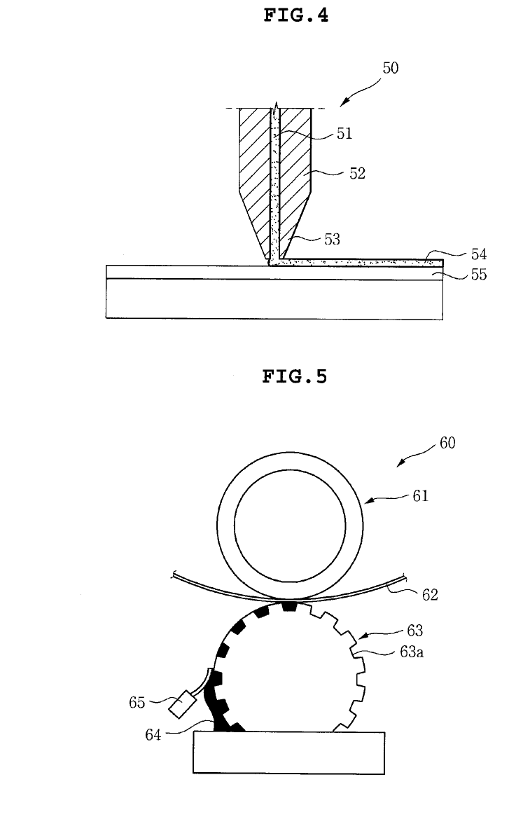

FIG. 2 is a schematic view showing a method for forming a laminated core according to a first embodiment of the present invention, FIG. 3 is a schematic view showing a method for forming a laminated core according to a second embodiment of the present invention, and FIG. 4 is a schematic view showing a method for forming a laminated core according to a third embodiment of the present invention.

A laminated core according to an embodiment of the present invention used in a motor such as an electric motor, or the like, is made of a magnetic powder material and configured to have a structure in which one or more unit laminates are laminated.

The material powder material, i.e., a soft magnetic complex (SMC), used for the laminated core according to an embodiment of the present invention is used as a material of an inductor, a stator, a rotor, an actuator, a sensor, and a transformer core for an electric device. In general, the soft magnetic core such as a rotor and a stator of an electric device is formed of stacked steel laminates. The soft magnetic composite (SMC) material is made of soft magnetic particles. In general, it is based on iron-based particles coated with electrically insulating material. That is, a soft magnetic composite component is fabricated by compressing particles, which are insulated by using a powder metal process, with a lubricant or a binder selectively. Since the soft magnetic composite material is able to accommodate a three-dimensional magnetic flux by using the powder metal technique and have a three-dimensional form through the compression process, an SMC component having a higher degree of freedom can be fabricated.

Also, soft magnetic powder (or metal powder) particles have various shapes such as a three-dimensional shape (e.g., polyhedral shape such as a rectangular shape, or the like, an oval shape such as a spherical shape, or the like, a cylinder-like shape, a donut-like shape, and the like) and two-dimensional thin film shape (e.g., a thin slice chip-like shape, a flake-like shape, and the like), and a polyamide-based resin, or the like, serve as a binder between or among the soft magnetic powder particles to maintain the structural strength and shape.

In particular, in case of amorphous soft magnetic powder particles, a polyamide-based resin, or the like, serves as a binder between or among powder particles having a certain three-dimensional shape or two-dimensional thin film shape, to maintain the structural strength and shape.

However, the formation of the core with the soft magnetic composite has a problem in which the strength is degraded in comparison to the existing core fabrication. Thus, in an embodiment of the present invention, a core having a laminated structure using such a soft magnetic composite is fabricated.

Namely, a unit laminate is formed by using the soft magnetic composite, and fabricated unit laminates are laminated in a thicknesswise direction to fabricate a core. Here, the unit laminate is formed to have a thickness of 1 mm or smaller, and a plurality of thin unit laminates are laminated to thus further enhance mechanical strength.

FIG. 1A is a perspective view of a stator core 10 formed to have a lamination structure by using the soft magnetic composite according to an embodiment of the present invention. Since the core 10 is formed by using the soft magnetic composite, it has an effect of reducing or preventing a loss of an eddy current and enhancing efficiency, or the like, and since the stator core 10 is formed to have a lamination structure, it can have increased mechanical strength. In particular, in forming the core 10 having a lamination structure, a unit laminate 11 has a thickness of 0.1 mm or smaller. Thus, since the core 10 is fabricated by laminating the unit laminates 11 each having the thickness of 0.1 mm or smaller, the core 10 can have a more enhanced mechanical strength and a loss of an eddy current can be prevented through the SMC, thus improving efficiency.

As shown in FIG. 1B, a core 20 having a lamination structure using a soft magnetic composite is formed by laminating unit laminates 21, and in this case, an insulating layer 22 is formed between the unit laminates 21.

Also, a magnetic material causes a loss of energy due to a hysteresis and an eddy current loss when exposed to a varied magnetic field. The hysteresis loss is proportional to the frequency of an alternating magnetic field, while the eddy current loss is proportional to the square of frequency. Thus, the eddy current loss is significant, and it would be desirous to increase resistance to maintain a low level of hysteresis loss while reducing the eddy current loss. In order to enhance resistance, powder particles may be coated with an insulating material or coated by a thin film.

Moly-permalloy powder (MPP) (81% Ni-17% Fe-2% Mo), among nickel-based alloys, and SENDUST (85% Fe-9.5%/si-5.5% Al) as an iron-based alloy may be used as a material of the soft magnetic composite according to an embodiment of the present invention, but the present invention is not particularly limited thereto and, of course, various materials which may be selected by a skilled person in the art may be used as a material of the soft magnetic composite.

FIGS. 2 through 4 are schematic views showing a method for forming a laminated core. A method for fabricating a core having a lamination structure will be described with reference to FIGS. 2 through 4.

FIG. 2 is a schematic view showing a method for forming a laminated core using spin-coating according to a first embodiment of the present invention.

As for the method of using spin coating, a generally used spin-coating apparatus for spin-coating a coating liquid including soft magnetic composite has such a basic structure as illustrated in FIG. 2. With reference to FIG. 2, the spin-coating apparatus includes a nozzle 31 for providing a coating liquid including a soft magnetic composite, a chuck 32 attached to a cup 35 and checking a support 33, and a motor 35 for rotating the chuck 32 along with the support 33. The spin-coating method aims at, in particular, making the thickness of the unit laminate uniform. The spin-coating method includes homogenization step and a follow-up drying step. In the homogenization step, in order to uniformly apply the coating liquid including a soft magnetic composite, the support is rotated by selecting a pre-set rotation speed, a predetermined rotation duration, and the square of the pre-set rotation speed and the certain rotation duration according to a desired thickness of a unit laminate. In the drying step, the support 33 is rotated at a rotation speed lower than the pre-set rotation speed during the homogenization step, and accordingly, a unit laminate is formed by the soft magnetic composite. A plurality of unit laminates may be laminated in a thicknesswise direction to fabricate a core having a lamination structure.

FIG. 3 is a schematic view showing a method for forming a laminated core using screen printing according to a second embodiment of the present invention.

Through screen printing, a coating liquid 41 including a soft magnetic composite is tightly attached to a screen 43 by using a squeegee 42 to form a unit laminate. Here, of course, the unit laminate appropriate for a core fabrication can be formed by adjusting the shape of a pattern of the screen 43. Also, this method is advantageous in that the pattern of a core shape can be fabricated by the screen 43.

FIG. 4 is a schematic view showing a method for forming a laminated core using slot die coating according to a third embodiment of the present invention.

Slot die coating refers to supplying a liquefied fluid (slurry, an adhesive, a hard coating agent, ceramic, etc.) to a space between upper and lower mold plates having the interior designed by Rheology called slot die and processed, by using a pulseless pump or a piston pump to coat the fluid supplied from a liquid supply pipe with a uniform thickness in a widthwise direction of a proceeding direction of a material, film, a glass plate, or a sheet. As shown in FIG. 4, a unit laminate layer 54 may be formed by applying a coating liquid 51 including a soft magnetic composite to a front surface 55 through a nozzle 53 of a slot die 52. A core having a lamination structure may be fabricated by laminating a plurality of thusly formed unit laminate layers 54 in a thicknesswise direction.

FIG. 5 is a view showing a method for forming a laminated core by using Gravure roll printing according to a fourth embodiment of the present invention.

As shown in FIG. 5, a pattern region 63a is implemented on a surface of a copper plate roller 63, and a coating liquid 64 including a soft magnetic composite is injected through a lower roller 63 by using a blade 65 so as to be laminated on a base substrate 62 between an upper roller 61 and the lower roller 63, thus implementing a soft magnetic core shape having a desired pattern two-dimensionally, and then, the soft magnetic core shape is laminated three-dimensionally by using a lamination device to thus fabricate a soft magnetic core having a three-dimensional shape.

According to the preferred embodiments of the present invention, since the core of a motor such as an electric motor, or the like, is formed by using a soft magnetic composite, a loss of an eddy current can be prevented, thus improving efficiency.

Also, since the core is fabricated by laminating the soft magnetic composites, the core formed of the soft magnetic composites can have enhanced mechanical strength.

Also, since the core is formed by using the soft magnetic composite, the degree of freedom in the design of the core can be increased.

In addition, since the core is formed by using the soft magnetic composite, the usage amount of copper can be reduced.

Although the preferred embodiments of the present invention have been disclosed for illustrative purposes, they are for specifically explaining the present invention and thus a laminated core and a fabrication method thereof according to the present invention are not limited thereto, but those skilled in the art will appreciate that various modifications, additions and substitutions are possible, without departing from the scope and spirit of the invention as disclosed in the accompanying claims.

Accordingly, any and all modifications, variations or equivalent arrangements should be considered to be within the scope of the invention, and the detailed scope of the invention will be disclosed by the accompanying claims.

What is claimed is:

1. A laminated core used for a motor including an electric motor,
wherein the core is formed of a soft magnetic composite and has a structure in which one or more unit laminates are laminated.

2. The laminated core as set forth in claim 1, wherein an insulating layer is laminated between the unit laminates in the soft magnetic composite lamination structure.

3. The laminated core as set forth in claim 1, wherein each of the unit laminates of the soft magnetic composite lamination structure has a thickness of 1 mm or smaller in a lamination direction.

4. A method for fabricating a laminated core, the method comprising:
forming a unit laminate by using a soft magnetic composite through a spin-coating method;
and
laminating a plurality of unit laminates in a thicknesswise direction.

5. The method as set forth in claim 4, wherein an insulating layer is further laminated between the unit laminates.

6. The method as set forth in claim 4, wherein each of the unit laminates has a thickness of 1 mm or smaller in a lamination direction.

7. A method for fabricating a laminated core, the method comprising:
forming a unit laminate by using a soft magnetic composite through a slot die coating method;
and
laminating a plurality of unit laminates in a thicknesswise direction.

8. The method as set forth in claim 7, wherein an insulating layer is further laminated between the unit laminates.

9. The method as set forth in claim 7, wherein each of the unit laminates has a thickness of 1 mm or smaller in a lamination direction.

10. A method for fabricating a laminated core, the method comprising:
forming a unit laminate by using a soft magnetic composite through a screen printing method;
and
laminating a plurality of unit laminates in a thicknesswise direction.

11. The method as set forth in claim 10, wherein an insulating layer is further laminated between the unit laminates.

12. The method as set forth in claim 10, wherein each of the unit laminates has a thickness of 1 mm or smaller in a lamination direction.
